(19) United States
(12) Patent Application Publication
(10) Pub. No.: US 2018/0133826 A1
(43) Pub. Date: May 17, 2018

(54) SOLDERING DEVICE

(71) Applicant: ERSA GMBH, WERTHEIM (DE)

(72) Inventor: Richard Kressmann, Zell am Main (DE)

(73) Assignee: ERSA GMBH, WERTHEIM (DE)

(21) Appl. No.: 15/725,960

(22) Filed: Oct. 5, 2017

(30) Foreign Application Priority Data
Oct. 5, 2016 (DE) 10 2016 118 789.5

(51) Int. Cl. B23K 3/06

(52) U.S. Cl. CPC B23K 3/0638

(57) ABSTRACT

A soldering device, in particular a soldering crucible for selective flow soldering, having a solder reservoir which is designed for storing a solder, in particular a molten solder, with a soldering nozzle and with a solder pump which is designed for conveying the solder out of the solder reservoir through the soldering nozzle, wherein the soldering device has an upper part and a lower part, wherein the upper part is releasably connectable to the lower part, and comprises the solder reservoir and the soldering nozzle, wherein a feed channel of the solder pump is disposed in the upper part and a device for generating a moving magnetic field of the solder pump is disposed in the lower part, designed (said device for generating a moving magnetic field) for generating a moving magnetic field along the feed channel.

### CROSS-REFERENCE TO RELATED APPLICATIONS

This application claims priority to German patent application No. 102016118789.5, filed on Oct. 5, 2016, the entire disclosure of each of which is incorporated herein by reference.

### BACKGROUND OF THE INVENTION

The invention relates to a soldering device, in particular a solder crucible for selective flow soldering, with a solder reservoir designed for storing solder, in particular a liquid solder, with a soldering nozzle and a solder pump designed for conveying the solder out of the solder reservoir through the soldering nozzle.

Such soldering devices are known in various forms from the prior art. However, it has been found that such soldering devices or solder crucibles are often associated with certain disadvantages when used in soldering systems for flow soldering. For example, it is a disadvantage that when using solders comprised of different alloys, it is necessary to have a supply of a large number of soldering devices or solder crucibles because different types of solder should not be mixed in the solder reservoirs of the soldering devices or solder crucibles. Thus a separate solder crucible with a substantial solder volume to be kept on reserve must be provided for each type of solder.

### SUMMARY OF THE INVENTION

Therefore, the object of the present invention is to make available a soldering device, in particular a solder crucible for selective flow soldering, with which variable production, on the one hand, and a reduction in operating costs and setup times, on the other hand, can be made possible.

This object is achieved by a soldering device having the features of claim 1. Such soldering devices are characterized in that the soldering device comprises an upper part and a lower part, wherein the upper part is releasably connectable to the lower part and comprises the solder reservoir and the soldering nozzle, wherein a feed channel of the solder pump is disposed in the upper part, and wherein a device for generating a moving magnetic field of the solder pump is disposed in the lower part, said device being designed for generating a moving magnetic field along the feed channel. Due to the fact that the upper part is releasably connected to the lower part and comprises the solder reservoir and the soldering nozzle, the components of the soldering device and/or the solder crucible, which are subject to increased wear, can be replaced easily. It is conceivable that a soldering device may be used with the same lower part in each of several soldering systems, wherein the upper part of the soldering device can be replaced easily and comparatively inexpensively, depending on the intended purpose or the wear condition of the upper part of the soldering device, without having to service the entire soldering device and/or the entire solder crucible. Furthermore, for different types of solder, i.e., for solders with different alloys, an upper part may be provided for each wherein several upper parts may be provided for alternate use with at least one lower part for the use as intended in a system for selective flow soldering. This design takes up much less space in comparison with the prior art. Therefore, due to the use of different upper parts and lower parts in a soldering system, an increased flexibility can be achieved with regard to the solder alloy, nozzle size and processing of multiple uses. Furthermore, an increased safety can be achieved with regard to wear, so that shorter down times can be achieved due to the redundant availability of the respective tool.

The feed channel advantageously runs along a circular path in at least some sections, wherein the device for generating a moving magnetic field comprises at least one magnet, in particular at least one permanent magnet, and is designed so that the magnetic is in movement along the feed channel during use.

In order to easily and reliably convey, i.e., pump liquid solder out of the solder reservoir to the soldering nozzle, it has proven advantageous if the feed channel has an inlet and an outlet, wherein the inlet is fluidically connected to the solder reservoir and wherein the outlet is fluidically connected to the soldering nozzle.

According to a particularly advantageous refinement of the soldering device, it is provided that a connecting device is provided that is designed for releasable connection of the upper part and the lower part.

For example, it is conceivable for the connecting device to comprise a bayonet closure and/or a magnetic closure. However, it is also possible that a different type of force-locking and/or form-fitting connection is selected.

To maintain the solder in a molten state in the solder reservoir, it is proven advantageous if a heating device is provided, which is positioned at least partially in the lower part and is designed to heat the solder reservoir. It is possible here for the heating device to be designed as an inductive heating device, for example, wherein an alternating magnetic field is generated in the lower part and a layer of ferromagnetic material is provided in the upper part.

To be able to move the soldering device and/or solder crucible in a soldering system, it has proven advantageous if a drive device designed to move the soldering device is provided.

It is especially preferable if the drive device is disposed in the lower part.

It is possible that the drive device comprises at least one electric motor and at least one drive wheel disposed on the lower part and connected to the electric motor.

Another advantageous embodiment of the solder device provides that an adjustment device, which is designed for relative displacement of the soldering nozzle along a Z axis, is provided. The adjusting device is advantageously arranged in the lower part. With this adjusting device, the soldering nozzle of a solder crucible can be shifted from a resting position into a soldering position with respect to a circuit board to be processed. It is conceivable for the adjusting device to be driven electrically. It is particularly advantageous if the adjusting device is controllable by a control unit, in particular a central control unit of a soldering system, so that individual solder crucibles can be input into and output out of an ongoing soldering program of a soldering system.

According to another advantageous refinement of the soldering device, it is provided that a pressurized storage designed for storage of a compressed gas under an excess pressure is provided in the lower part. The pressurized storage is advantageously designed for storing nitrogen.

It has proven advantageous if a first compressed gas line that is fluidically connectable to the pressurized storage is provided in the lower part, and wherein a second compressed gas line, which is disposed in such a way that the second compressed gas line is fluidically connected to the first compressed gas line when the upper part is disposed on the lower part, is provided in the upper part. The second compressed gas line advantageously has an outlet, which opens in the region of the soldering nozzle, so that compressed gas, for example, nitrogen, can be directed from the lower part to the soldering nozzle of the upper part during operation of the soldering device and/or the solder crucible.

To be able to convey, i.e., pump, solder from the solder reservoir to the soldering nozzle it is advantageous if the device for generating a moving magnetic field is designed so that the permanent magnet rotates about an axis of rotation arranged concentrically with the circular path during operation.

It is advantageous here to provide a plurality of permanent magnets which alternately face the feed channel in alternation with different magnetic poles. It is particularly advantageous if the permanent magnets are arranged on a magnetic circular path, which is concentric with the circular path of the feed channel, wherein the magnetic circular path has a magnetic circular path diameter and wherein the circular path of the feed channel has a circular path diameter, such that the magnetic circular path diameter and the circular diameter are identical or almost identical. It is particularly advantageous if the device for generating a moving magnetic field comprises an electric motor, such that the at least one permanent magnet can be driven to rotate about the axis of rotation of the electric motor. In addition, it is advantageous if a magnetic or ferromagnetic material is provided on the side of the feed channel facing away from the permanent magnet in the upper part of the device.

### BRIEF DESCRIPTION OF THE DRAWINGS

Additional details and advantageous refinements of the invention can be derived from the following description, on the basis of which one specific embodiment of the invention is described and explained in greater detail.

In the drawings:

FIG. 1 shows a schematic side view of a soldering device according to the invention;

FIG. 2 shows a schematic view of a section of the soldering device according to FIG. 1; and

FIG. 3 shows a feed channel of the soldering device according to FIG. 1 in a view from above.

### DETAILED DESCRIPTION

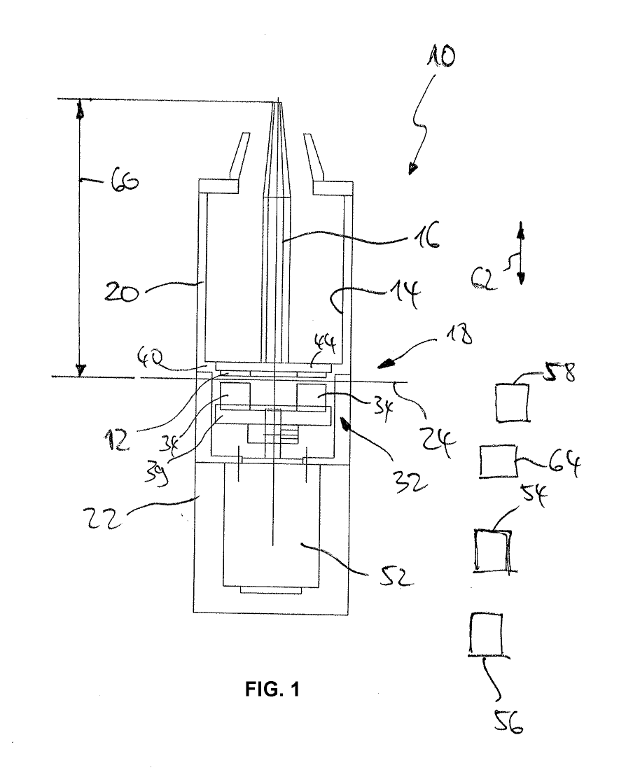

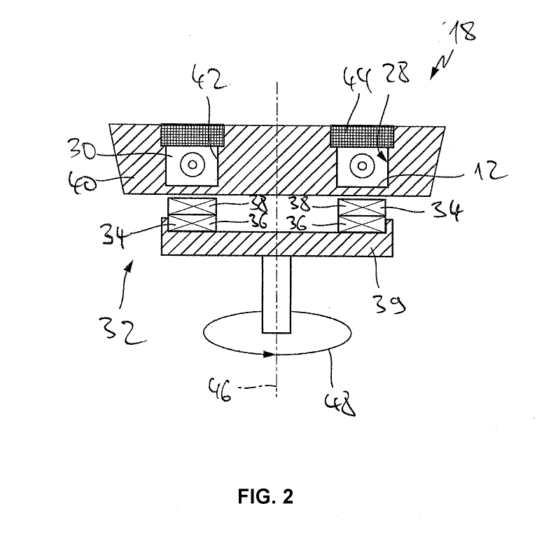

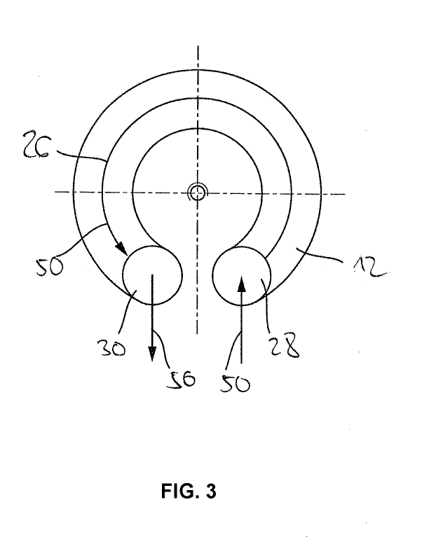

FIG. 1 shows a schematic side view of a soldering device 10 according to the invention, in particular a solder crucible for selective flow soldering, wherein FIG. 2 shows an enlarged schematic view of a section of the soldering device 10 according to FIG. 1. FIG. 3 furthermore shows a feed channel 12 of the soldering device 10 according to FIG. 1. Corresponding components and elements in the figures are labeled with the corresponding reference numerals.

The soldering device 10 has a solder reservoir 14, which is designed for storage of solder, in particular a molten solder as well as a soldering nozzle 16. In addition, the soldering device 10 has a solder pump 18, which is designed for conveying the solder out of the solder reservoir 14 and through the soldering nozzle 16, so that a standing wave of solder can be created for selective flow soldering.

The soldering device 10 has an upper part 20 and a lower part 22, wherein the upper part 20 can be connected releasably to the lower part 22 and comprises the solder reservoir 14 and the soldering nozzle 16. For a releasable connection of the upper part 20 to the lower part 22, a connecting device (not shown in the figures), designed for releasable connection of the upper part 20 and the lower part 22, may be provided. For example, it is conceivable for the connecting device to comprise a bayonet closure and/or a magnetic closure. However, it is also possible for a different type of force-locking and/or form-fitting connection to be selected. The upper part 20 and the lower part 22 can be separated from one another in the area of a plane of separation 24, which is illustrated schematically in FIG. 1.

A feed channel 12 of the solder pump 18 is arranged in the upper part 20 of the soldering device 10. This feed channel 12 is shown in FIG. 1 but can be seen more clearly in FIGS. 2 and 3.

In at least some sections, the feed channel 12 runs along a circular path 26 (cf. FIG. 3) and has both an inlet 28 and an outlet 30, such that the inlet 28 is fluidically connected to the solder reservoir 14, and the outlet 30 is fluidically connected to the soldering nozzle 16. The feed channel 12 is shown schematically in FIG. 3 in a view from above. The inlet 28, the outlet 30 and the circular path 26 can be seen clearly. The inlet 28 and the outlet 30 are arranged on the ends of the feed channel 12 facing away from one another.

The soldering device 10 also has a device for generating a moving magnetic field 32, which is arranged in the lower part 22 of the soldering device 10. The device for generating a moving magnetic field 32 comprises at least one permanent magnet 34 and is designed so that the permanent magnet 34 is moved along the feed channel 12 during operation. In the embodiment according to FIGS. 1 to 3, the soldering device 10 and/or the device 20 comprises a plurality of permanent magnets 34, which face the feed channel 12 with different magnetic poles 36, 38 in alternation.

The permanent magnets 34 are arranged on a magnetic circular path (not shown in the figures) concentric with the circular path 26 of the feed channel 12, a permanent magnet 34 being arranged with the south pole 38 upward, facing the conveying channel 12, and the permanent magnet 34 arranged next to it has the north pole 36 facing upward. In FIG. 2, the permanent magnets 34 are mounted on a magnet disk 39, which is also shown clearly in FIG. 1.

As can be seen in FIGS. 1 and 2, the feed channel 12 is bordered by a non-ferromagnetic material 40, in which a groove 42 has been formed. This groove 42 is sealed by a ring 44 of ferromagnetic material, wherein the feed channel 12 is bordered on the whole by the non-ferromagnetic material 40 and the ferromagnetic ring 44.

The device 32 for generating a moving magnetic field is designed, so that the permanent magnets 34 rotate during operation about an axis of rotation 46, which is concentric with the circular path 26 or the magnetic circular path. By rotation of the permanent magnets 34 arranged axially (parallel to the direction of the axis of rotation 46) beneath the feed channel 12, a moving magnetic field can be generated in the feed channel 12, developing between the ferromagnetic material 44 and the permanent magnets 34. During operation of the solder pump 18 of the soldering device 10 in an electrically conductive fluid, in particular in a molten solder, eddy currents can be generated by the moving magnetic field. By generating the eddy currents, the electrically conductive fluid and/or the molten solder can be accelerated along a direction of rotation along the feed channel 12 running in at least some sections along the circular path 26, as represented by the arrow 48 in FIG. 2 or by the arrows 50 in FIG. 3, and thus a pumping action of the solder pump 18 can be made available.

To drive the magnet disk 39, the solder pump 18 has an electric motor 52 which is shown schematically in FIG. 1 and which drives the magnet disk 39 and/or the permanent magnets 34 in such a way that the magnet disk and/or the permanent magnets rotate about the axis of rotation 46. The magnet disk 39 is advantageously manufactured from a ferromagnetic material, in particular a ferrous material.

Due to the fact that the upper part 20 is releasably connected to the lower part 22 and has the solder reservoir 14 and the soldering nozzle 16, the components of the soldering device 10 and/or of the solder crucible which are subject to increased wear can be replaced easily. It is conceivable here that a soldering device 10 in a soldering system may be used with the same lower part 22 in each case, wherein the upper part 20 of the soldering device 10 can be replaced easily and comparatively inexpensively, depending on the intended purpose or the wear condition, without having to service the entire soldering devices 10 and/or the entire solder crucible.

To liquefy the solder in the solder reservoir 14, a heating device 54 which is shown schematically in FIG. 1 and is arranged in the lower part 22 and designed for heating the reservoir 14 is provided. It is possible here for the heating device 54 to be designed as an inductive heating device, for example, wherein a magnetic alternating field is generated in the lower part 22 and a layer of ferromagnetic material is provided in the upper part 20.

Furthermore, a drive device 56, which is shown schematically in FIG. 1 is designed for moving the soldering device 10 in a working space and is arranged in or on the lower part 22. The drive device 56 has at least one electric motor which is provided in addition to the electric motor 52. Furthermore, the drive device 56 has at least one drive wheel which is arranged on the lower part 22 but is not shown in the figures and is connected to the electric motor.

The soldering device 10 also has an adjusting device 58 as shown schematically in FIG. 1, designed for relative displacement of the soldering nozzle 16 along a Z axis. The adjusting device 58 may in particular be designed for adjusting the distance 60 between the soldering nozzle 16 and an immovable section of the lower part 22 so that a type of Z-axis drive can be implemented in the direction of the double arrow 62. With the adjusting device 58 the soldering nozzle 16 of a soldering device 10 and/or a solder crucible can be shifted out of a resting position and into a soldering position with respect to a circuit board to be processed. It is conceivable here for the adjusting device 58 to be electrically driven. It is particularly advantageous here if the adjusting device 58 is controllable by a control unit, in particular a central control unit of a soldering system so that individual soldering devices 10 or solder crucibles can be input into and output from an ongoing soldering program of a soldering system.

A pressurized storage device 64 which is indicated in FIG. 1 and is designed for storing a compressed gas under an excess pressure is provided in the lower part 22 of the soldering device 10. The pressurized storage device 64 is advantageously designed for storing nitrogen. A first compressed gas line (not shown in the figures) is provided in the lower part 22 and can be fluidically connected to the pressurized storage device 64, wherein a second compressed gas line (not shown in the figures) is provided in the upper part 20 and is arranged in such a way that the second compressed gas line is fluidically connected to the first compressed gas line with the upper part 20 being disposed on the lower part 22. The second compressed gas line has an outlet which opens in the region of the soldering nozzle 16, so that compressed gas, for example, nitrogen can be directed from the lower part 22 to the soldering nozzle 16 of the upper part 20 during operation of the soldering device 10 and/or the solder crucible.

What is claimed is:

1. A soldering device, in particular a soldering crucible for selective flow soldering, having a solder reservoir which is designed for storing a solder, in particular a molten solder, with a soldering nozzle and with a solder pump which is designed for conveying the solder out of the solder reservoir through the soldering nozzle, characterized in that the soldering device has an upper part and a lower part, wherein the upper part is releasably connectable to the lower part, and comprises the solder reservoir and the soldering nozzle, wherein a feed channel of the solder pump is disposed in the upper part, and a device for generating a moving magnetic field of the solder pump is disposed in the lower part, said device being designed for generating a moving magnetic field along the feed channel.

2. The soldering device according to claim 1, wherein the feed channel runs along a circular path for at least some sections and wherein the device for generating a moving magnetic field comprises at least one magnet, in particular at least one permanent magnet and is designed so that the magnet is moved along the feed channel during operation.

3. The soldering device according to claim 1, wherein the feed channel has an inlet and an outlet, the inlet being fluidically connected to the solder reservoir and the outlet being fluidically connected to the soldering nozzle.

4. The soldering device according to claim 1, wherein a connecting device designed for releasable connection of the upper part and the lower part is provided.

5. The soldering device according to claim 4, wherein the connecting device comprises a bayonet closure and/or a magnet closure.

6. The soldering device according to claim 1, wherein a heating device designed for heating the solder reservoir is provided and is disposed at least partially in the lower part.

7. The soldering device according to claim, wherein a drive device designed for moving the soldering device is provided.

8. The soldering device according to claim 7, wherein the drive device is disposed in the lower part.

9. The soldering device according to claim 7, wherein the drive device comprises at least one electric motor and at least one drive wheel that is disposed on the lower part and is connected to the electric motor.

10. The soldering device according to at least one of the preceding claims, wherein an adjusting device designed for relative displacement of the soldering nozzle along a Z axis is provided.

11. The soldering device according to claim 1, wherein a pressurized storage device designed for storing a compressed gas under an excess pressure is provided in the lower part.

12. The soldering device according to claim 11, wherein a first compressed gas line, which can be connected to the pressurized storage device, is provided in the lower part, and wherein a second compressed gas line, which is disposed in such a way that the second compressed gas line is fluidically connected to the first compressed gas line when the upper part is disposed on the lower part is provided in the upper part.

13. The soldering device according to claim 2, wherein the device for generating a moving magnetic field is designed so that the permanent magnet rotates about an axis of rotation arranged concentrically with the circular path during operation.

14. The soldering device according to claim 2, wherein a plurality of permanent magnets is provided, alternately facing the feed channel with a different magnetic pole.
